(19) United States
(12) Patent Application Publication
(10) Pub. No.: US 2012/0170881 A1
(43) Pub. Date: Jul. 5, 2012

(54) GM AUTOMATIC TRANSMISSION 700R4 THROUGH 4L70E INCREASE IN INPUT SHAFT BEARING SURFACE AREA ON REAR STATOR BUSHING

(76) Inventor: Luther Preston Deans, Clayton, NC (US)

(21) Appl. No.: 13/340,554

(22) Filed: Dec. 29, 2011

Related U.S. Application Data
(60) Provisional application No. 61/427,956, filed on Dec. 29, 2010.

(51) Int. Cl. F16C 17/02; B23P 19/02

(52) U.S. Cl. 384/416; 29/525

(57) ABSTRACT

The present invention relates generally to the system and method for extending lifetime of automatic transmission, and more specifically to the system and method for extending lifetime of GM 700r4 through 4I70e automatic transmissions input shaft rear stator bearing by increasing the bearing surface area on rear stator bearing. By increasing the durability of the rear stator bearing, the most common failures in the transmission, which are the failure of the input output shaft lubrication seal, rear planetary failure, and the binding and burning of the clutch pack, can be overcome. The present invention increases the rear stator bearing life, the input output shaft oil seal life, the rear planetary life, and the clutch pack life.

### REFERENCE TO RELATED APPLICATIONS

This patent application claims the benefit of U.S. Provisional Application No. 61/427,956 filed on Dec. 29, 2010, the disclosure of which is incorporated herein by reference in its entirety.

### BACKGROUND OF THE INVENTION

1. Field of the Invention

The present invention relates generally to the system and method for extending lifetime of automatic transmission, and more specifically to the system and method for extending lifetime of GM 700r4 through 4I70e automatic transmissions input shaft rear stator bearing by increasing the bearing surface area on rear stator bearing.

2. Description of Related Art

Since GM first introduced the four speed automatic overdrive in the Corvette in 1982, the 700r4 had many failures; the factory made improvements every year along with the aftermarket transmission improvement industry as disclosed in U.S. Pat. Nos. 5,503,601; 7,195,578; 7,527,577; 7,608,010; and U.S. PreGrant Pub. Nos. 2006/0122027; 2008/0167157; 2009/0258753; and 2010/0210408.

One of a few remaining problems is the premature wearing of the small rear stator bearings. Wear of the rear stator bushing greatly shortens the long term durably of these transmissions. At 50,000 miles that rear stator bushing wear causes failures to start in other areas that seem unrelated to the rear stator bushing. The stator supports the rotating input shaft on two bushings one being in the front and one being in the rear. The rear bushing supports the heavy rotating input drum that overhangs the rear bushing; this overhanging load greatly increases the load placed on the small bushing.

The two most common failures in the transmission are caused by the wear on the rear stator bushing; the failure of the input output shaft lubrication seal causing loss of lubrication and rear planetary failure; and the binding and burning of the clutch pack.

The failure of the input output shaft lubrication seal is caused by the excess movements of the input shaft and output shaft due to wear on the rear stator bushing. The outer circumference of the oil seal is connected to the input shaft and inner circumference of the seal is connected to the output shaft. As the stator bearing wears, the input shaft has increasing movement; excess movement of both input and output shafts crushes the oil seal between the two shafts causing loss of lubrication oil to the gear train. The rear planetary failure is very common from lack of lube oil.

The GM 700r4 thru 4I70e family of automatic transmissions is known to have rapid input to output oil seal wear. The premature input to output oil seal wear caused many transmission failures from the lack of lubrication. Failure of this oil seal is observed during overhauls with low mileage that was due to other problems, for example four wheel drives with large tires can cause breakage to planetary gears due to torque. During these low mileage rebuilds, many observations show the seal is leaking at 40,000 miles and at 75,000 miles completely worn out. Transmission life at 60,000 becomes very questionable, especially at highway speeds in overdrive, towing and long trips.

The rear stator bearing wear inducing the excess movement also causes binding and burning problems of the clutch packs, especially the 3/4 clutch. The 3/4 clutch pack binds when the clutch is applied and released, inside the clutch pack the steel pressure plates are connected the input drum and the friction plates are connected to the output shaft. The excess movements between the input and output shafts due to the rear stator bearing wear causes binding and burning of the clutch pack.

Therefore, there is an obvious need to have a solution to overcome the aforementioned problems such as premature of oil seal, oil leakage, transmission failure, and 3/4 clutch alignment binding problems due to the rear stator bearing premature wear.

### SUMMARY OF THE INVENTION

One object of the invention is to provide a new rear stator bearing design that can increase the surface area to support the overhung bearing loads placed by the input shaft drum thus extending lifetime of the rear stator bearing.

Another object of the invention is to provide a new rear stator bearing design that can increase the input output shaft oil seal life due to less movement between the input shaft and output shaft and increase the rear planetary life due to better lubrication because of less lube oil loss.

Yet another object of the invention is to provide a new rear stator bearing design that can reduce the movement between the input and output shaft and reduce the binding and burning of 3/4 clutch pack so as to increase overall durability.

Still object of the invention is to provide a new rear stator bearing design that can replace the current rear stator bearing design of OEM automatic transmissions. The bearing can be employed during rebuild of transmissions or manufacturing of a new transmission.

Yet another object of the invention is to provide an automatic transmission that utilizes the new rear stator bearing design so as to extend the shelf life of the automatic transmissions.

The present invention overcomes the aforementioned transmission failures due to the premature wear of small stator bearing and input to output shaft oil seal such as oil leakage, transmission failure, and 3/4 clutch alignment binding problems.

The input shaft is supported by two bearings in stator housing. The rear stator bearing does not have enough bearing surface area to support the overhung bearing loads placed by the input shaft drum. This causes the bearing to wear prematurely.

By increasing the length of input shaft journal and the stator housing bore length and the bearing length, the rear stator bearing can have more the bearing surface area to support the overhung heavy loads placed by the input shaft drum, thus extending the lifetime of the rear stator bushing.

In order to achieve the goal, three parts are modified according to the present invention. The journal on the input shaft is extended by pressing on a sleeve over the existing lube oil hole and drilling a new lube hole on a new location. The stator housing length is increased by boring a longer bearing hole. The length of bushing is increased. By modifying these three parts, the bearing length and surface area to support the overhung heavy loads placed by the input shaft drum is increased, thus overcoming the premature wear problem of the rear stator bearing.

The present invention provides for an improved rear stator bearing design to replace currently used rear stator bearing design. These new designed parts including an input shaft with extended journal, a longer bushing, and a stator housing with a longer bore length may be products modified from existing parts and done in machine shops or they can be designed into new manufacturing products. These new designed parts may be installed during rebuild of a transmission or may be parts of a new transmission to increase durability of the rear stator bearing. By extending the lifetime of the rear stator bearing, the premature oil seal, oil loss, rear planetary failure, and clutch binding and burning problems due to excess movement between input shaft and output shaft can be prevented. The preferred length of the longer bushing according to the present invention is approximately 0.75 inch and the sleeve is approximately 0.25 inch because clearance is needed for sleeve not to contact stator.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 shows a perspective view of a partial input shaft assembly and partial output shaft assembly wherein the input shaft is visible.

FIG. 2 shows a perspective view of new designed parts according to one embodiment of the present invention including a modified input shaft with extended journal (top) versus an OEM unmodified input shaft (bottom).

FIG. 3 shows a rear view of the stator with bushing removed.

FIG. 4 shows a flow diagram of a method to improve the rear stator bearing lifetime according to the present invention.

### DESCRIPTION OF THE PREFERRED EMBODIMENT

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The stator supports the rotating input shaft on two bearings (bushings), one being in the front and one being in the rear. The rear stator bearing supports the heavy rotating input drum that overhangs the rear bearing. Currently, the rear stator bearing does not have enough bearing surface area to support the overhung bearing loads placed by the input shaft drum. This causes the bearing to wear prematurely.

The new input shaft design and rear bearing (bushing) design according to the present invention can overcome this problem by increasing the length of input shaft journal and the stator housing bore length and the rear bearing length, thus extending the lifetime of bearings. Broadly, an embodiment of the present invention can be used generally provides for an improved input shaft design and rear bearing (bushing) design to replace currently used input shaft and rear bearing (busing). The improved input shaft design and rear bearing (bushing) design can be used in place of currently used input shaft design and rear bearing (bushing) design. The input shaft is supported by two bearings in stator housing.

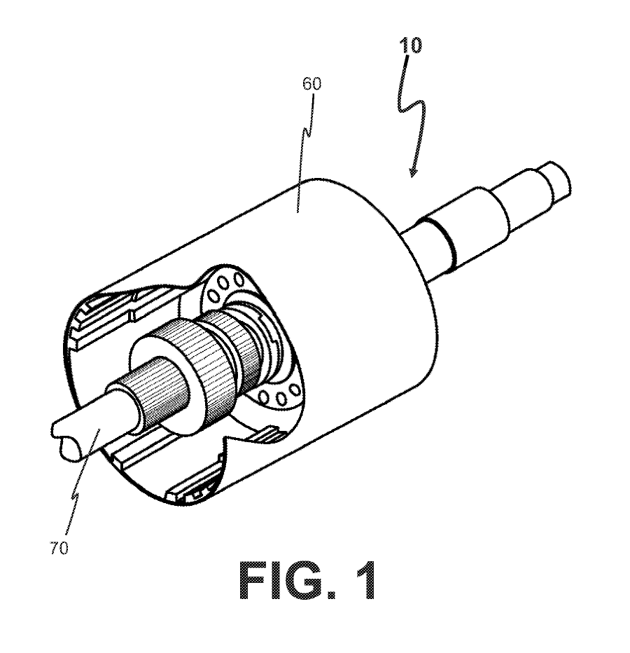

Referring to FIG. 1 there is disclosed a perspective view of an input shaft assembly 60 and output shaft assembly 70, wherein the input shaft 10 is observed but the rear stator bearing 40 is not visible.

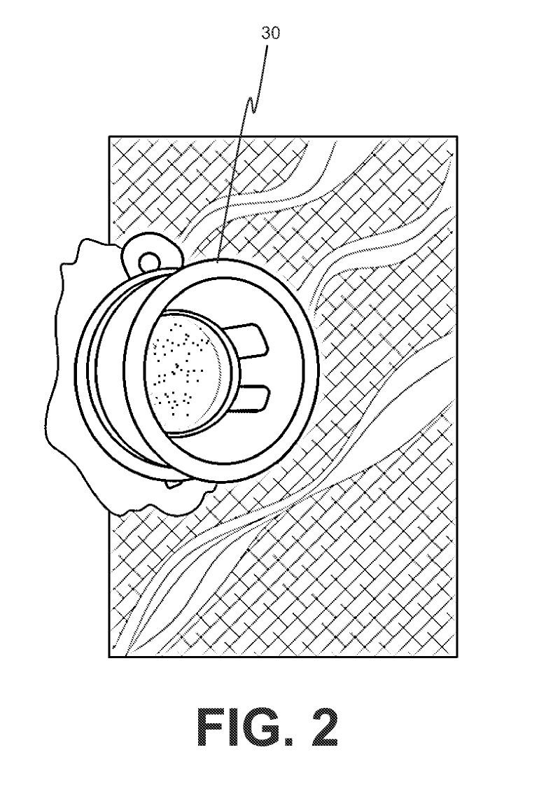

FIG. 2 shows a perspective view of an embodiment of the new input shaft with extend journal 10 on the top and the OEM input shaft 20 on the bottom. In comparison with the OEM one 20 (bottom), the new input shaft with extended journal 10 (top) has a sleeve 12 of approximately 0.25 inch and a relocated hole 14 on the input shaft.

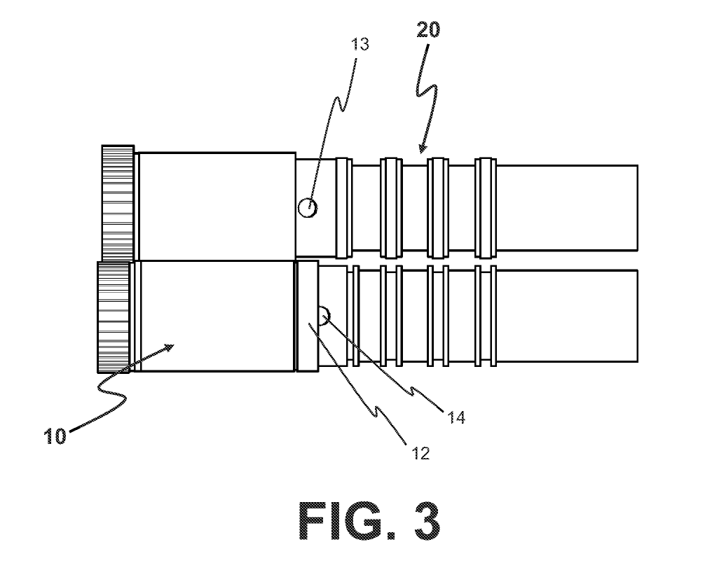

Referring to FIG. 3 there is disclosed a rear view of the stator housing 30 with the bushing removed. Normally, the stock stator housing 30 will accept standard bushing length of 0.470 inch and aftermarket length of 0.510 inch. In order to increase the input shaft bearing surface area on the rear stator bushing 40 thus extending the lifetime of the rear stator bushing 40, the present invention increases the length of the bushing 40 by boring the depth of the stator housing 30 and installing a longer bushing of approximately 0.750 inch. The new input shaft 10 with an extended journal as disclosed in FIG. 2 is then replacing the old input shaft and is put inside the stator housing 30. By using the input shaft with extended journal 10 and longer bushing 40 in a stator with a longer bore 30, the input shaft 10 journal length can be increased by 0.250 inch.

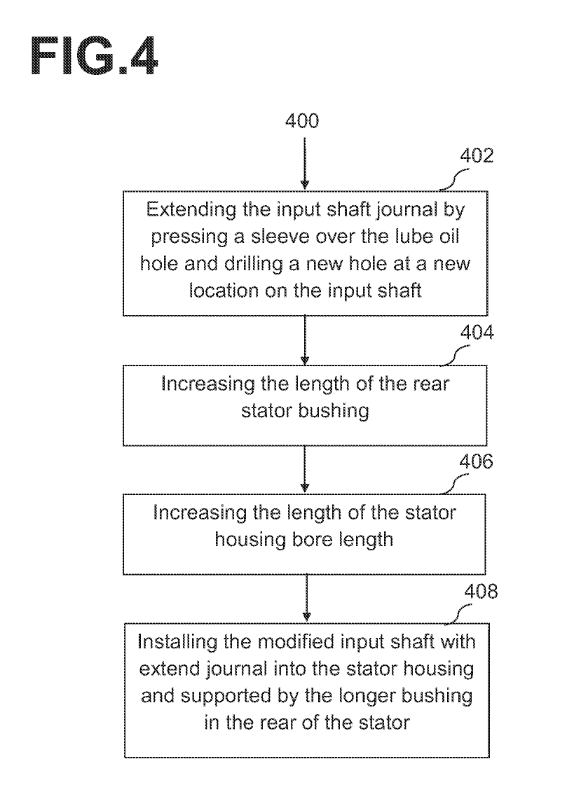

The method 400 of making the new and improved input shaft and bushing on the rear stator bearing according to the present invention illustrated in FIG. 4 comprises four steps: first at step 402, the journal on the input shaft 10 is extended by pressing on a sleeve 12 over the lube oil hole 13 and drilling a new lube hole 14 at a new location; secondly at step 404, the bushing length is increased; at step 406, the stator housing 30 bearing length is increased by boring; and finally at step 408, installing the longer bushing 40 into the rear of stator housing 30 and installing the input shaft 10 with extended journal into the stator housing 30. The method 400 of improving the lifetime of the rear stator bearing 40 may be used in modifying the existing parts in machine shop or when designed into new manufacturing. The method 400 may be used during a rebuild of a transmission or manufacturing of a new transmission to increase durability.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A highly durable rear stator bearing system for increasing the bearing surface area to support the input shaft drum thus increasing input output oil seal life, 3/4 clutch life and rear planetary life comprising:
a. a rear stator bushing of approximately 0.75 inch long;
b. an input shaft with extended journal that is compatible with the bushing; and
c. a stator with a bore length that is compatible with the bushing.

2. A method of increasing the bearing surface area to support the input shaft drum by modifying the existing OEM parts thus increasing input output oil seal life, 3/4 clutch life and rear planetary life comprising:
a. extending the input shaft journal by pressing on a sleeve over the existing lube oil hole and drilling a new hole at a new location on the input shaft;
b. increasing the rear stator bushing length; and
c. increasing the stator housing bearing length by boring.

3. An automatic transmission with increasing bearing surface area to support the input shaft drum thus increasing input output oil seal life, 3/4 clutch life and rear planetary life comprising:
a. a rear stator bushing with length of approximately 0.75 inch; and
b. an input shaft with extended journal that is compatible with the bushing; and
c. a stator with bore length that is compatible with the bushing.

4. The method of claim 2 further comprising installing the input shaft with extended journal into the stator and installing the rear stator bushing to support the input shaft.

5. The method of claim 2 wherein the rear stator busing is increased up to approximately 0.75 inch.

6. The method of claim 2 wherein the journal of the input shaft is extended by approximately 0.25 inch.

7. The system of claim 1 can be employed during rebuild of transmissions or during the initial manufacture of transmissions.

8. The method of claim 2, wherein the sleeve is approximately 0.25 inch.

9. The system of claim 1, wherein the input shaft with extended journal is prepared by pressing on a sleeve over the input shaft, the length of input shaft with extended journal is increased by 0.25 inch due to the sleeve.

10. The system of claim 1 can increase input output shaft oil seal life.

11. The system of claim 1 can decrease binding of 3/4 clutch thus increasing 3/4 clutch lifetime.

12. The system of claim 1 can prevent lube oil loss thus extending rear planetary life due to better lubrication.
